(19) United States
(12) Patent Application Publication
(10) Pub. No.: US 2010/0288568 A1
(43) Pub. Date: Nov. 18, 2010

(54) PRESSURE SENSITIVE TOUCH-SURFACE CONTROL DEVICE

(75) Inventors: Patrice Laurent, Annemasse (FR); Xavier Drouin, Annemasse (FR)

Correspondence Address: OSHA LIANG L.L.P., TWO HOUSTON CENTER, 909 FANNIN, SUITE 3500, HOUSTON, TX, 77010, US

(73) Assignee: DAV, Creteil (FR)

(21) Appl. No.: 12/670,828

(22) PCT Filed: Jul. 21, 2008
(86) PCT No.: PCT/EP08/59510

§ 371 Date: Apr. 13, 2010

(30) Foreign Application Priority Data
Jul. 31, 2007 (FR) 0705594

(51) Int. Cl. G08C 21/00

(52) U.S. Cl. 178/18.03

(57) ABSTRACT

The invention relates to a touch-surface control device (1) including a sensor (3) having a surface (3) that is sensitive to a variation of the touch pressure and a holder (5) bearing said sensor (3), characterised in that the sensor (3) is floatingly mounted on the holder (5) and in that the holder (5) includes a positioning means (17) interacting with an inactive area (11) of the sensor (3) for positioning the sensor (3) on the holder (5).

The present invention relates to an electric device for control by touch-sensitive surface using pressure-sensitive resistors (also known under the name of FSR for “Force Sensing Resistor” sensor), particularly for control devices of motor vehicles such as a motorized mechanism for opening and/or closing at least one opening element or an electronic member for a multimedia screen or an air conditioning system.

More recently it has been proposed to use for these controls touch-sensitive surfaces making it possible to detect a simple pressure of the finger in order to trigger a particular type of action or control, such as for a vehicle member control, depending on the position of the pressure detected and/or the subsequent movement of this pressure on the surface.

These touch-sensitive surfaces increasingly use the technology of force sensing resistors which is ahead of other equivalent technologies, such as, for example, capacitive or else optical technologies, by virtue of its ease of application and its robustness.

Such sensors are, for example, known under the name of “digitizer pad” and the following documents are cited as prior art: U.S. Pat. No. 4,810,992, U.S. Pat. No. 5,008,497, FR 2683649 or else EP 0 541 102.

These sensors comprise semiconductive layers sandwiched between, for example, a conductive layer and a resistive layer. When a pressure is applied to the FSR layer, its ohmic resistance decreases, thus making it possible, by the application of an adapted voltage, to measure the pressure applied and/or the location of the place where the pressure is exerted.

During the assembly of the sensor in the control device, the bottom surface of the sensor may be attached by bonding to a support provided for this purpose. However, this assembly technique may pose problems.

In particular, depending on the materials to be bonded and the adhesive used, it is possible to observe a partial separation of the sensor for considerable variations in temperature fluctuating between −40° C. and 85° C.

The object of the present invention is therefore to propose an electric control device having a better behavior with respect to outside temperature variations.

Accordingly, the subject of the invention is a control device with touch-sensitive surface comprising a sensor the surface of which is sensitive to a variation of touch pressure and a support supporting the sensor, characterized in that the sensor is mounted so as to float on the support and in that the support comprises a positioning means interacting with a dead zone of the sensor in order to position the sensor on the support.

Other advantages and features will appear on reading the description of the invention and the appended drawings in which:

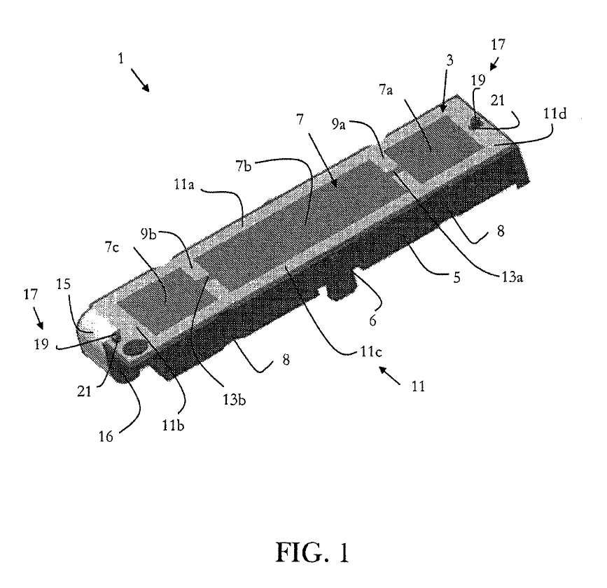

FIG. 1 is a view in perspective of the control device according to a first embodiment of the invention,

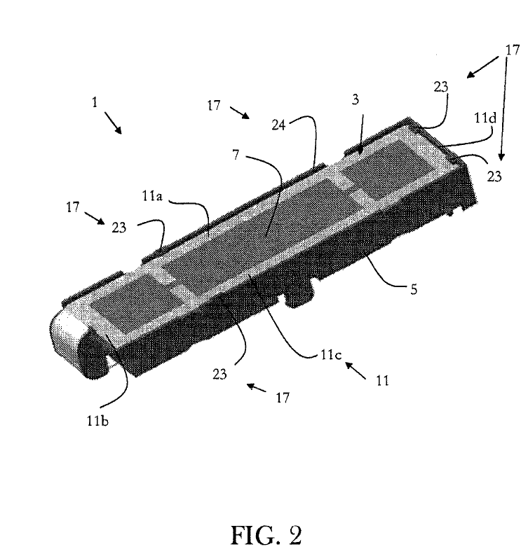

FIG. 2 is a view in perspective of the control device according to a second embodiment of the invention,

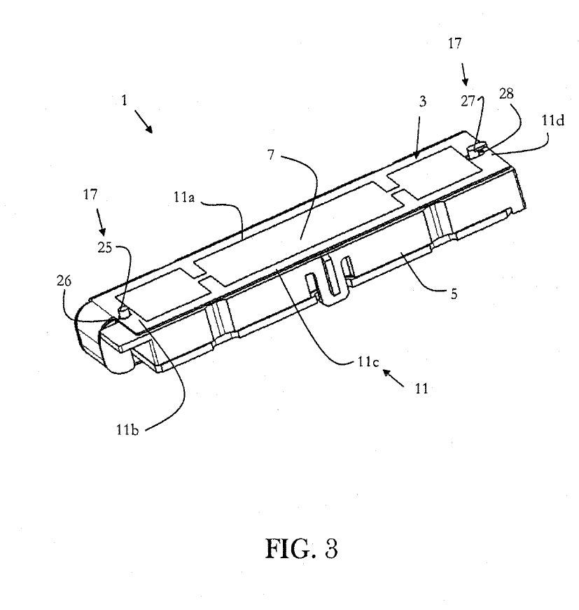

FIG. 3 is a view in perspective of the control device according to a third embodiment of the invention.

In these figures, identical elements bear the same reference numbers.

FIG. 1 shows a control device 1 according to the invention for example capable of controlling a motorized mechanism (not shown) for opening and/or closing an opening element, such as for example a window of a motor vehicle, a sunroof or else the trunk, tailgate, motorized sliding door of a vehicle.

Naturally, this type of device can be adapted to any other electric control of a motor vehicle such as an electric seat control or light control such as an overhead reading light or interior lighting.

The touch-sensitive electric control device 1 comprises a sensor 3 supported by a support 5 particularly designed to be covered by a protective coating and assembled with a printed circuit board in a casing, not shown.

For this, the support 5, made of plastic for example, comprises in particular means 6 for snap-fitting to the casing and lateral notches 8 allowing the passage of fastening screws of a cover and of a bottom fitting into one another in order to form the casing (not shown).

The sensor 3 has a surface 7 sensitive to a variation of touch pressure (also known under the name of FSR for “Force Sensing Resistor” sensor), that is to say using pressure-sensitive resistors.

These sensors comprise flexible semiconductive layers sandwiched between, for example, a conductive layer and a resistive layer. By exerting a pressure or a slide on the FSR layer, its ohmic resistance decreases thus making it possible, by the application of an adapted electric voltage, to measure the pressure applied and/or the location of the place in which the pressure is exerted.

According to a different concept of the FSR technology, the touch-sensitive sensor comprises two flexible sheets of support spaced apart from one another by elastic spacers and carrying on mutually facing faces elements making it possible to achieve an electric contact when the sensor is compressed.

The touch-sensitive surface 7 comprises three adjacent active zones 7a, 7b, 7c corresponding to the active zones for controlling in these zones a specific electric function.

Preferably, the touch-sensitive surface 7 comprises two inactive transverse regions 9a and 9b, and a peripheral region 11, consisting of lateral regions 11a to 11d, also called dead zones.

The transverse dead zones 9a and 9b are traversed by passageways 13a, 13b of the signal of the sensor 3.

The touch-sensitive surface 7 of the sensor 3 comprises connection means 15 at its end, in order to provide the electric connection with, for example, the printed circuit board (not shown).

Advantageously, not only the touch-sensitive surface sensor 3 but also the connection means 15 are arranged to be flexible. Therefore, it is possible to envisage that the connection means 15 are formed by an extension of the sensor 3.

Similarly, it is advantageously possible to provide a guiding protuberance 16 made in a single piece on a lateral face of the support 5 in order to guide the connection means 15.

According to the invention, the sensor 3 is mounted so as to float on the support 5 and the support 5 comprises a positioning means 17 interacting with a dead zone 11 of the sensor 3 in order to position the sensor 3 on the support 5.

The sensor 3 mounted so as to float on the support 5 makes it possible to avoid problems associated with the differences of heat-expansion coefficients, between the sensor 3, the support 5 and the adhesive, which occur in the devices of the prior art.

Specifically, the sensor 3 can therefore move slightly by sliding on its support 5 when the control device 1 is subjected to considerable heat variations.

Since the sensor 3 is mounted so as to float, the positioning means is essential for ensuring that the location of the active zone of the surface 7 of the sensor 3 correctly corresponds to the location of the specific control requested by the user.

Therefore, the device 1 makes it possible to solve the problems of the prior art associated with the means for attaching the sensor 3 to the support 5 by bonding.

Moreover, the positioning means 17 interacts with a dead zone 11 of the sensor 3, which makes it possible to optimize the space requirement of the control device 1 by avoiding a loss of the active surface 7 of the sensor 3.

Also, the sensor 3 is positioned in a removable manner on the support 5, which makes it possible to change it or reposition it easily if necessary.

Provision is made for the surface 7 of the sensor 3 to be adjusted in the support 5.

According to the embodiment illustrated in the figures, the surface 7 and the support 5 have a parallelepipedal form and the positioning means 17 and the corresponding dead zones 11b and 11d are situated on the opposite lateral borders of the longitudinal ends of the device 1, in order to better position the sensor 3 on the support 5.

FIG. 1 illustrates a first embodiment of the device 1 in which the positioning means 17 comprises at least one centering pin 19 interacting with at least one corresponding hole 21 formed in a dead zone 11 of the sensor 3.

Provision is made for the hole 21 to have an opening, for example circular, with a size slightly greater in section than the centering pin 19, so as to allow the sensor 3 to slide slightly around the pin 19.

Advantageously, the positioning means 17 of the device comprises two centering pins 19 situated on the opposite lateral borders of the support 5 which interact respectively with two corresponding holes 21 formed in a dead zone 11a, 11b of the sensor 3.

Therefore, the touch-sensitive surface 7 of the sensor 3 is drawn out over the support 5 by the two centering pins 19.

This gives a compact manufacturing unit comprising the sensor 3 assembled to the support 5, advantageously connected to a printed circuit board, which can be handled independently during the assembly phases of the manufacturing methods.

It is also possible to have lateral notches 8 of the support 5 used as an additional positioning means by providing corresponding cut-outs in the lateral dead zones 11a, 11c of the sensor 3.

Advantageously, provision is made for the device 1 to comprise attachment means, not shown in this figure, for attaching the sensor 3 to the support 5 in a removable manner.

For example, provision is made for these attachment means to be formed by the casing of the device 1, sandwiching the sensor 3 between the support 5 and the protective coating.

According to a second embodiment of the device 1 schematized by FIG. 2, the positioning means 17 comprises at least one retaining hook 23 which interacts with a peripheral dead zone 11 of the sensor 3.

In this embodiment, provision is made for the sensor 3 advantageously to comprise a peripheral dead zone 11 around the active zone 7 the lateral dimension of which is sufficient to allow it to interact with the retaining hook 23.

Similarly, provision is advantageously made for the support to comprise a raised peripheral border 24 surrounding the sensor 3 in which the retaining hooks 23 are formed.

The border 24 and the retaining hooks 23 form a means 17 for positioning the sensor 3 in the support 5 and the retaining hooks 23 also allow the retention of the sensor 3 in the device 1.

Advantageously, two retaining hooks 23 interact with a peripheral dead zone 11d of the lateral face opposite to the electric connection means 15 of the sensor 3.

Specifically, the flexible connection means 15 already form a means for positioning on this face of the sensor 3.

Preferably, the device 1 also comprises at least one retaining hook 23 interacting with a peripheral dead zone 11a, 11c of each longitudinal face of the sensor 3.

According to a third embodiment illustrated in FIG. 3, the positioning means 17 comprises at least one centering pin 25 interacting with a corresponding hole 26 and at least one coupling tooth 27 interacting with a corresponding oblong hole 28.

The pin 25 and the coupling tooth 27 make it possible to position the sensor 3 on the support 5 and the coupling tooth 27 also makes it possible to retain the sensor 3 on the support 5.

Moreover, the oblong hole 28 allows the lateral positioning of the sensor 3 on the support 5, while allowing the sensor 3 to slide slightly longitudinally around the coupling tooth 27.

Preferably, the centering pin 25 and the coupling tooth 27 are situated on the opposite borders of the support and interact with corresponding holes 26 and 28 formed in corresponding dead zones 11b and 11d, opposite to one another in the length of the sensor 3.

It is understood that, with such a control device 1 with a touch-sensitive surface having a sensor 3 mounted so as to float on the support 5 and a positioning means 17 interacting with a dead zone 11 of the sensor 3 in order to position the sensor 3 removably on the support 5, the resistance of the control device 1 to heat stresses is improved and its service life is thus increased.

1. A control device with a touch-sensitive surface comprising:
a sensor comprising the touch-sensitive surface, wherein the surface is sensitive to a variation of touch pressure; and
a support supporting the sensor,
wherein the sensor is mounted so as to float on the support, and the support comprises a positioning means interacting with a dead zone of the sensor to position the sensor on the support.

2. The device as claimed in claim 1, wherein the positioning means and corresponding dead zones are situated on opposite lateral borders of longitudinal ends of the device.

3. The device as claimed in claim 1, wherein the positioning means comprises at least one centering pin interacting with at least one corresponding hole formed in the dead zone of the sensor.

4. The device as claimed in claim 3, wherein the hole has an opening with a size greater in section than the centering pin to allow the sensor to slide around the pin.

5. The device as claimed in claim 3, further comprising two centering pins situated on each border of the lateral faces of the support and interacting respectively with two corresponding holes formed in the dead zone of the sensor.

6. The device as claimed in claim 3, wherein the positioning means further comprises at least one coupling tooth interacting with a corresponding oblong hole formed in the dead zone of the sensor.

7. The device as claimed in claim 1, wherein the positioning means comprises at least one retaining hook interacting with a peripheral dead zone of the sensor.

8. The device as claimed in claim 7, further comprising two retaining hooks interacting with a peripheral dead zone of the lateral face opposite to the electric connection means of the sensor.

9. The device as claimed in claim 7, further comprising at least one retaining hook interacting with a peripheral dead zone of each longitudinal face of the sensor.

10. The device as claimed in claim 1, further comprising attachment means for attaching the sensor to the support in a removable manner.
